(19) United States
(12) Patent Application Publication
(10) Pub. No.: US 2004/0137244 A1
(43) Pub. Date: Jul. 15, 2004

(54) Surface treatment for increasing transmission of a transparent article

(76) Inventors: Eitan Zeira, Hollis, NH (US); Lee Batchelder, Derry, NH (US)

Correspondence Address: EDWARD S. SHERMAN, 5698 EAGLE ROCK CT., SANTA ROSA, CA, 95409, US

(21) Appl. No.: 10/746,097

(22) Filed: Dec. 24, 2003

Related U.S. Application Data
(60) Provisional application No. 60/437,412, filed on Dec. 30, 2002.

(51) Int. Cl. B32B 27/00

(52) U.S. Cl. 428/447; 428/421

(57) ABSTRACT

The reflectivity of a hardcoated optical element is reduced via modification of the surface topography. Selective etching of the hardcoat surface in an alcoholic solution containing dissolved alkali or basic reagent results in increased transmission; yet without significantly effecting the haze or light scattering or other desirable optical property

### CROSS REFERENCE TO RELATED APPLICATIONS

This application claims priority to the provisional patent application having serial No. 60/437,412 and filed on Dec. 30, 2002

### FIELD OF INVENTION

This invention relates to a method of imparting a lower reflectance to a transparent article by surface modification.

### BACKGROUND OF INVENTION

When light travels through a transparent object, part of the light “bounces back” or reflects causing unwanted glare or reflected images. In many applications, this imparts a significant loss to the performance of the article. As examples Ophthalmic lenses, displays of various sorts (e.g. monitors, televisions, picture frames), and telescopes and the like suffer a loss of as much as 8% of the light that travels through them. This phenomenon has been well known to us for a long time and various methods throughout the past have been proposed and utilized to reduce that unwanted reflection.

The principle of these proposed methods involve adding coatings onto the surface of the article that significantly reduce the back reflection. They are generally known as “anti-reflective coatings”. The method generally employs a plurality of thin films differing in their refractive index on a substrate by multi-coating procedures. U.S. Pat. Nos. 3,781,090; 3,799,653; 3,854,796; 3,914,023; 3,984,581 and 4,196,246, among others, all speak to various multilayers of inorganic oxide layers onto polymeric ophthalmic lenses.

To deposit the aforementioned coatings, many techniques have been used such as vacuum evaporation, sputtering (for improving adhesion) and electron beam evaporation method. However, it is problematic to apply such coatings onto plastic or polymeric materials by these methods. In the last few years this has become more of an issue as polymeric materials are finding more and more uses as optical elements such as spectacle lenses, TV screens and various plastic films and sheets that are subsequently applied to windows, and display screens. Numerous problems arise when these coating methods are applied, especially to the plastic materials having a hardcoat formed on them for improving scratch and impact resistance.

More specifically, polymeric materials have relatively poor heat resistance and cannot withstand the thermal stress imparted by the above-mentioned coating processes. This causes deformation, pitting, crazing and even melting of the substrates during the deposition process. Furthermore, the adhesion is ordinarily poor on plastic materials. These disadvantages are mainly due to differences in the expansion coefficient and surface energy between a plastic material and the inorganic substance to be coated thereon. If the adhesion is extremely reduced when the plastic material is exposed to an elevated temperature or a high humidity, cracks and other defects are often formed in the inorganic coating layer.

A more serious problem is that the impact resistance and flexibility of a hardcoated plastic material are drastically reduced by formation of such brittle inorganic substances onto it. Namely, the superiority of plastic materials to glass materials is lost by the presence of such coatings.

A less well known alternative to multilayer anti-reflection are optical devices in which surface reflections are reduced by altering the surface topography to provide a relief pattern that somehow diminishes reflection losses, and increases transmission. A moths' eye has such a relief structure, comprising a regular array of conical protuberances. This is believed to suppress reflections by providing a graded refractive index between the air and the cornea and thereby contribute to reduce reflection (Bernard, C. G., Endeavor 26, pp. 79-84 (1967)). This recognition has led to the suggestion that a glass lens having such a surface would exhibit similar reductions in reflectivity. One method for providing such an altered surface is disclosed by Nicoll et. al. in U.S. Pat. No. 2,445,238 which proposes a method for reducing reflections from glass surfaces by exposing the glass to a vapor of hydrofluoric acid. This was thought to form a microscopically roughened glass surface which is similar to a structure of a moth's eye. Difficulties in reproducing these “skeletonized” structures and in maintaining a uniform structure over the entire surface area of optical devices has led others to develop alternative structures. Moulton (U.S. Pat. No. 2,432,484) developed a technique for forming on glass surfaces a non-uniformly dispersed layer of colloidal particles containing a random arrangement of peaks to provide the antireflection characteristics. Lange et al. U.S. Pat. No. 4,816,333 discloses anti-reflective coatings of silica particles. The coating solution contains colloidal silica particles and optionally a surfactant (“Trition.TX.X-100” and “Tergitol TMN-6”) to improve the wettability of the coating solution. U.S. Pat. No. 4,374,158 (Tanigucki et al.) discloses an anti-reflective coating using a gas phase treatment technique. Clapham in U.S. Pat. No. 4,013,465 teaches that a clear article may have reduced reflection to a particular wavelength band provided that the surface of such articles have specific protuberances on its surface; “having a height not less than ⅓ the longest wavelength and a spacing that is shorter than the shortest wavelength divided by the index of refraction of the material”. Numerous patents have been granted which have demonstrated that imparting a nanostructure to a surface dramatically reduced back reflection of visible light from it. However, none of these anti-reflective techniques produced a durable coating (Cathro et al. in “Silica Low-Reflection Coatings for Collector Covers by a Dye-Coating Process,” Solar Energy, Vol. 32, No. 5, pp. 573-579 (1984); and by J. D. Masso in “Evaluation of Scratch Resistant and Antireflective Coatings for Plastic Lenses,” Proceedings of the 32^{nd} Annual Technical Conference of the Society of Vacuum Coaters, Vol. 32 p. 237-240 (1989)).

It is therefore, the object of this invention to impart antireflection properties to a durable surface, thereby, providing both antireflection and mechanical durability (such as scratch resistance, flexibility, impact resistance) to an optical element.

It is another object of the invention to provide a process that can impart antireflective properties to an optical element without difficulty and complication of process.

It is another object of the present invention to provide a method of imparting an antireflection property to ophthalmic lenses as they are provided from the manufacturer without any additional layers

### SUMMARY OF INVENTION

In accordance with the present invention, there is provided a process for producing a hardcoated transparent shaped article having an enhanced anti-reflective effect, via the surface modification of the hardcoat itself. The present invention provides a method for modifying the surface of a hardcoat disposed on an optical element to provide the anti reflection property. The surface modification is achieved by controlled etching of the hardcoat itself. This affords the article both mechanical durability and antireflection in a single layer.

The above and other objects, effects, features, and advantages of the present invention will become more apparent from the following description of the embodiments thereof taken in conjunction with the accompanying drawings.

### BRIEF DESCRIPTION OF DRAWINGS

FIG. 1 is a graph showing the wavelength dependence of the transmittance of each thick lens in example 2 (for treatment times of 35, 40, and 45 minutes) in comparison to a blank (untreated) lens and a commercial antireflective lens (AR).

FIG. 2 is a graph showing the wavelength dependence of the transmittance of each thin lens in Example 2 (for 40, 50 and 60 minutes) in comparison to a blank (untreated) lens and a commercial antireflective lens (AR).

### DETAILED DESCRIPTION

The term “etchant” in this embodiment is generally referred to any alkali or basic material such as sodium hydroxide, potassium hydroxide and related material that can partially dissolve and or hydrolytically react with inorganic and organic surfaces and mixed inorganic-organic surfaces.

Optical elements of the present invention, such as Ophthalmic lenses, protective eyewear, picture frames, display screens, solar cells, windows and the like, are preferably already supplied with an organic or polymeric hardcoat that provides scratch resistance to the element.

A hard-coated optical article is dipped in an aqueous or alcoholic solution of an alkali such as Sodium Hydroxide. The concentration of the etchant is preferably from 2%-30% by weight and more preferably between 10% and 20%. The treatment time is from 2 minutes to one hour at 10° C. to 40° C., but more preferably at room temperature. The resultant article, after washing and drying, embody superior anti reflective properties, along with other performance benefits attributable to the remaining hardcoat.

If the optical article does not have a hardcoat, one must be coated onto the article by any method known to one skilled in the art prior to the etching step. The hardcoat has been established as a means of providing mechanical durability to polymeric optical articles. As hardcoats can be applied to organic and inorganic surfaces, the invention is not limited to polymeric optical articles. Suitable transparent hardcoats are well known in the art, and comprises at least a cross-linked polymer matrix and generally some portion of inorganic filler that is well dispersed therein being formed of colloidal particles of silica, alumina, Titania, tin oxide and the like. Many hardcoats are formed from polymeric resins having at least in part a siloxane (R1, R2-Si-0) repeat unit, while other resins may be formed or cross-linked via pendent or terminal acrylate groups.

If treated correctly, the polymeric optical devices of the present invention exhibit reflectance as low as 0.1%, and a relatively low uniform reflectivity throughout the visible region (380-700 nm). In contrast, untreated polymeric devices with or without a hardcoat typically exhibit reflectance on the order of about 4% from each surface.

The present invention is thus a significant improvement over prior art polymeric optical elements in both anti-reflection and mechanical durability.

To better elucidate the process and resulting anti-reflection properties a brief description of the process is outlined below:

Scratch resistant coated plastic lenses available from Silor Corporation (St. Petersburg Fla.) under the tradename “TRUETINT”consist of a siloxane type hardcoat material coated on “CR-39” type resin. These lenses were treated in the base solution system, as follows:

a. Sodium Hydroxide was dissolved in methanol and the concentration varied from 10% to 20% w/v.

b. The lenses were soaked in base solution for 5, 10, 20, 30, 35, 40, 45, 50 and 60 minutes.

c. Samples were washed in methanol using ultrasonic cleaning, and then dried at room temperature.

The percentage transmittance of each sample was measured and compared to both an untreated lenses and a commercial available lens having a conventional antireflective multiple layer coating. The results have shown the significant increase in percentage transmittance of the base treated material over the untreated material. Indeed, the base treatment method at the appropriate concentration and soaking times increases the circa 92% transmittance up to about 99.6%, which is higher than commercially available antireflective-coated ophthalmic lenses.

It appears that the conditions for controlled etching of the hard cover layer to produce a near ideal nano-structure for anti-reflection optical phenomenon is a function of the composition and reactivity of the etching solution, but also at least somewhat dependent on the chemical nature of the hard coat. Silor “TRUETINT” lenses are the currently preferred substrate for this process. Other commerical lens substrates include “SOLA” lenses.

We have come to appreciate that the solutions of methanol and sodium hydroxide may also comprise from 0% to perhaps as much as 30 percent water depending on the ambient humidity and atmospheric exposure time. It appears that the actual amount of water will vary the strength or aggressiveness of the etching, as a perfectly dry for anhydrous solution has been found not to attack the siloxane hardcoats in any reasonable amount of time. However, deliberately adding up to 30 percent water actually produces an etching solution so aggressive that it completely removes the hard coat in a relatively short period of time, leaving no practical treatment time range for process control and optimization. Lower water content and increased temperatures will affect etching in a reasonable amount of time depending upon the water concentration and temperature. It should be noted that while these etching procedures were originally developed for promoting adhesion of hard coats to bare ophthalmic lenses, that is “CR-39” resin, the criticality of the concentration of water, time and temperature of action has not been previously appreciated, as a broader range of chemical roughening of the bare lens surface will yield adequate adhesion without interfering with the desired optical performance of the subsequently hard coat lens.

Therefore, in the preferred embodiment of the inventive process the etching solution is made up from commercially available anhydrous methanol and sodium hydroxide such that the actual water concentration can be controlled by the addition of known amounts of water and conducting the etching process in a relatively low humidity environment (less than approx. 50% R.H.). Controlling the water content may also be achieved by maintaining the etching environment of an anhydrously prepared methanolic alkali solution at about 20 percent relative humidity, which is believed to produce a solution having between about 0.2% and 9% water, depending on the atmosphere exposure time. However, if it is not commercially practical to control the relative humidity within this range then the etching time, or base concentration, or etching temperatures should be lowered or altered accordingly from the conditions provided herein. Alternatively, one may also control the actual amount of water in the solution, preferably between about 2% to about 10%. In either case, the same sequence of time and temperature dependent tests can be used to determine the preferred treatment time for the given lens and/or hardcoat type.

By way of examples, the present invention will be further clarified as to what it means to “correctly” treat the surface.

### EXAMPLE 1

Sodium hydroxide was dissolved in methanol at various concentrations (5%, 10%, 15%, 20% w/w). The samples were soaked in the base solution for 10, 20, 30, 40, 50 and 60 minutes. The samples were then washed in methanol and dried at room temperature.

TABLE 1
Treatment in various concentrations and soaking time

| | % W/W | Soaking | |
|---|---|---|---|
| Sample # | of NaOH/MeOH | Time (min.) | AR property |
| 1 | 5% | 10 | No |
| 2 | 5% | 20 | No |
| 3 | 5% | 20 | No |
| 4 | 5% | 40 | No |
| 5 | 5% | 50 | No |
| 6 | 5% | 60 | No |
| 7 | 10% | 10 | No |
| 8 | 10% | 20 | No |
| 9 | 10% | 30 | No |
| 10 | 10% | 40 | Yes |
| 11 | 10% | 50 | Yes |
| 12 | 10% | 60 | Yes |
| 13 | 15% | 10 | Yes |
| 14 | 15% | 20 | Yes |
| 15 | 15% | 30 | Yes |
| 16 | 15% | 40 | Yes |
| 17 | 15% | 50 | Yes |
| 18 | 15% | 60 | Yes |
| 19 | 20% | 10 | No |
| 20 | 20% | 20 | Lightly |
| 21 | 20% | 30 | Yes |
| 22 | 20% | 40 | Yes |
| 23 | 20% | 50 | Yes |
| 24 | 20% | 60 | Yes |

### EXAMPLE 2

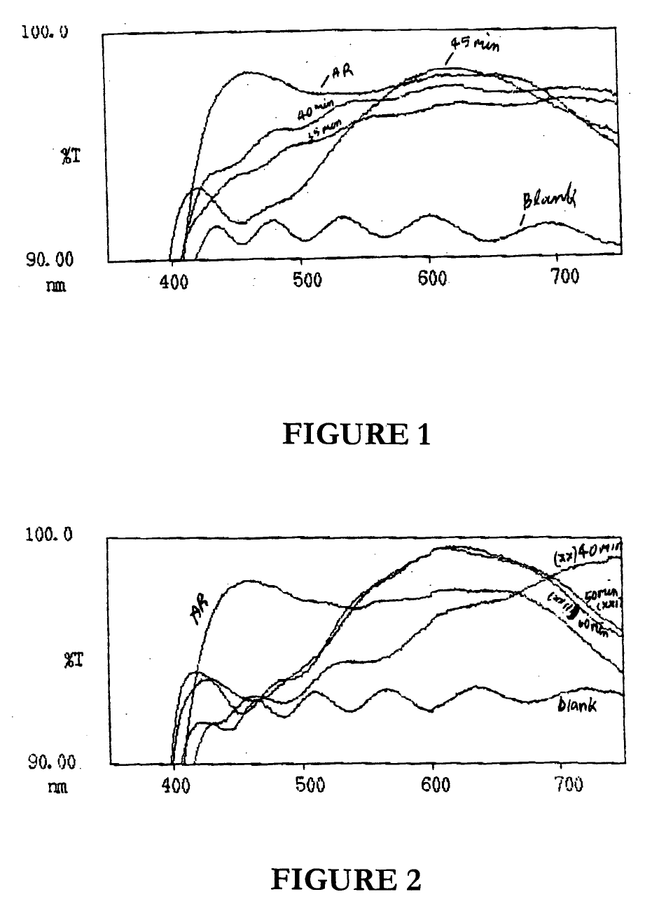

Two different thickness lenses were investigated by the base treatment system. Sodium hydroxide was dissolved in methanol at the concentrations of 10 w/v (12.7% w/w). The samples were soaked in the base solution for 30, 35, 40, 45, 50 and 60 minutes. Then the samples were washed in methanol and dried at room temperature. Transmittance of each lens was measured and compared with a blank lens and a commercial anti-reflective lens. FIG. 1 is a graph showing the wavelength dependence of the transmittance of each thick lens in example 2 (for treatment times of 35, 45 and 55 minutes) in comparison to a blank (untreated) lens and a commercial antireflective lens (AR). The modulation of transmission between about 90 and 92% of the blank lens (hardcoat without treatment) arises from the slight difference in refractive index of the hardcoat and resin that forms the bulk of the lens, the periodicity being related to the hardcoat thickness. However, as the average transmission increases with etching time this modulation weakens, having essentially disappeared after 45 minutes, when the transmission reaches a maximum value at about 600 nm.

FIG. 2 is a graph showing the wavelength dependence of the transmittance of each thin lens in Example 2 (for 40, 50 and 60 minutes) in comparison to a blank (untreated) lens and a commercial antireflective lens (AR). The variation between FIGS. 1 and 2 may be due to control of water in the methanol-sodium hydroxide solution, the lens thickness or batch-to-batch variations in the hardcoat chemical composition or structure. However, a peak in transmission of about 99.5% is still obtained at about 600 nm. Additionally, it appears that the process is self-stabilizing, as the transmission profiles after 50 and 60 minutes are essentially identical, exhibiting about the same average transmission (over 400 to 750 nm) as the conventional multi-layer (AR) treatment, that is an average transmission of greater than 95%.

### EXAMPLE 3

A 10% NaOH etch solution (w/w) is prepared by dissolving 50.0 g of NaOH (Reagent Grade Sodium Hydroxide) in 450.0 grams of anhydrous methanol (MeOH, 568.5 mL) plus 20.0 mL of deionized water (d. H₂O). A hardcoated optical lens (Silor TruTint® Lens; Silor, Division of Essilor of America, Inc., St. Petersburg, Fla.) is suspended in the NaOH etch solution for a period of 10 minutes at 21° C., after which time the lens is removed, rinsed with methanol and dried with a heat gun. Optical reflectance (450-750 nm) of the lens after etch treatment was <0.5% (optical reflectance of the untreated lens was 5.5%).

### EXAMPLE 4

A 10% NaOH etch solution (w/w) is prepared by dissolving 50.0 g of NaOH (Reagent Grade Sodium Hydroxide) in 450.0 g of anhydrous methanol (MeOH, 568.5 mL) plus 20.0 mL of deionized water (d. H₂O). A hardcoated optical lens (SOLA Lens; SOLA International Holdings Ltd, Lonsdale, South Australia) is suspended in the NaOH etch solution for a period of 20 minutes at 21° C., after which time the lens is removed, rinsed with methanol and dried with a heat gun. Optical reflectance (450-750 nm) of the lens after etch treatment was <0.5% (optical reflectance of the untreated lens was 5.0%).

It should be appreciated that alternative chemical etching agents or etchantsinclude solutions comprised of the following: A. Metal Hydroxide, where said metal includes any one or combination of the following: 1) Alkali metals (Group I Elements), such lithium, sodium, potassium and the like, 2) Alkaline earth metals (Group II Elements) such as magnesium, calcium and the like; B. Metal Alkoxide or Alcoholate, where said metal includes any one or combination of the following: 1) Alkali metals (Group I Elements), such lithium, sodium, potassium and the like, 2) Alkaline earth metals (Group II Elements) such as magnesium, calcium and the like; alternatively, the Alkoxide or Alcoholate is derived from any one or combination of methanol, ethanol, propanol and related homologs and isomers; and, ethylene glycol, propylene glycol, glycerol and related homologs and isomers; C. Ammonia, Ammonia Solution and Ammonium hydroxides; D. Quaternary Amine Hydroxides, where said quaternized amine may be ligated with alkyl, aryl, aralkyl, and related substituents; E. Fluoride Salts and Related Complexes, where the fluoride counterion includes any one or combination of: 1) Alkali metal (Group I Elements), such lithium, sodium, potassium and the like, 2) Alkaline earth metal (Group II Elements) such as magnesium, calcium and the like. 3.) Ammonium and the like. 4.) Quaternized amine, which said quaternized amine may be ligated with alkyl, aryl, aralkyl, and related substituents; and F. Dissolved or partially solubilized alkali metal and alkaline earth metal.

It should be appreciated that alternative solvents for the preparation and use of etchant solutions include any one or combination of the following: A. Alcohols such as methanol, ethanol propanol and related homologs and isomers, B. Glycols and Polyols such as ethylene glycol, propylene glycol, glycerol and related homologs and isomers, C. Amines such as ammonia, methylamine, ethylamine, propylamine and related homologs and isomers; and, polyamines such as ethylenediamine, diethylenetriamine and related homologs and isomers, D. Strongly polar aprotic solvents such as dimethylsulfoxide, dimethylformamide, hexamethylphosphoramide and related solvents, and E. Water.

Further, it should be appreciate the preparation and use in etchant solutions include any one or combination of the following additives: A. Surface Active or Wetting Agents for the lowering of the etchant solution surface tension; B. Cationic Surfactants as counterions or surface transport agents for the hydroxide, alkoxide, fluoride and related reactive anionic species; C. Metal Binding Agents and Chelators; and D. pH Modifying Agents

While the invention has been described in connection with a preferred embodiment, it is not intended to limit the scope of the invention to the particular form set forth, but on the contrary, it is intended to cover such alternatives, modifications, and equivalents as may be within the spirit and scope of the invention as defined by the appended claims.

1] A process for increasing the transmission of an article having a siloxane type hardcoat as an outer surface, the process comprising:
a) immersing the hardcoated article in solution of an alkali having a basic pH for a predetermined time and temperature to alter the hardcoat topography,
b) removing the hardcoated article from the alkali solution,
c) rinsing the hardcoated article in an alcohol or suitable solvent to remove excess base,
d) drying the hardcoated article to remove excess alcohol or solvent,
e) wherein the predetermined time and temperature is selected so as to be sufficient to increase the transmission by at least about 2%.

2] The method of claim 1 wherein the basic pH solution etches at least a portion of the hardcoat.

3] The method of claim 1 wherein the basic pH solution has a solvent selected from the group consisting of alcohols, glycols, amines, strongly polar aprotic solvent and water.

4] The method of claim 1 wherein the alkali reagant used to form the alkali solution is selected from the group consisting of a metal hydroxide, metal alkoxide or alcoholate, ammonia, ammonia solutions, ammonium hydroxides and quaternary amine hydroxides and dissolved alkali metal, dissolved alkaline earth metal, partially solubilized alkali metal and partially solubilized alkaline earth metal.

5] The method of claim 4 wherein the metal used to form the hydroxide or alkoxide is selected from the group consisting of alkali metals and alkaline earth metals.

6] The method of claim 4 wherein the alkoxide or alcoholate is derived from the group consisting of methanol, ethanol, propanol and related homologs and isomers; and, ethylene glycol, propylene glycol, glycerol and related homologs and isomers.

7] The method of claim 1 wherein the alkali reagent used to form the alkali solution is a fluoride salts and related complexes, where the fluoride counter ion is selected from the group consisting of alkali metal, alkaline earth metal, ammonium and quaternized amine.

8] The method of claim 1 wherein the etchant comprises at least one additive selected from the group consisting of surface active, wetting agents, cationic surfactants, metal binding agents, chelators and pH modifying agents.

9] A transparent optical element consisting essentially of:
a) a transparent body having a front surface,
b) an transparent organic hardcoat disposed on the front surface of said transparent body, wherein the average overall transmission through the hardcoat to the interior of the optical element, in the wavelength range of 450 to 650 nm, is greater than about 95%.

10] A transparent optical element comprising:
a) a transparent body having a front surface,
b) a transparent organic hardcoat disposed on the front surface of said transparent body as the external surface of the optical element,
c) wherein the internal transmission through the front surface is greater than 97%.

11] A transparent optical element according to claim 10 further comprising an transparent organic hardcoat disposed on the rear surface of said transparent body, wherein the average overall transmission at through the hardcoat to the interior of the optical element a wavelength range of 450 to 650 nm is greater than about 95%

12] A transparent optical element according to claim 9 wherein the transparent body is a lens.

13] A transparent optical element according to claim 9 wherein the transparent body is a plastic resin.

14] A transparent optical element according to claim 10 wherein the transparent body is a plastic resin.

15] A transparent optical element according to claim 10 wherein the hardcoat is a silicone polymer.

16] A transparent optical element comprising:
a) a transparent body having a front surface,
b) a transparent organic hardcoat deposited on the front surface of said transparent body, and etched to increase the overall transmission of the optical element by at least 2%.

17] A transparent optical element according to claim 16 wherein said organic hardcoat is etched to increase the overall transmission of the optical element by at least 3%

18] A transparent optical element according to claim 16 further comprising
a) a transparent organic hardcoat deposited on the back surface of said transparent body, and etched to increase the overall transmission of the optical element by at least 4%.

19] A transparent optical element according to claim 18 wherein the optical element is a lens.

20] A transparent optical element according to claim 18 wherein the optical element is a plastic

21. A transparent optical element according to claim 18 wherein the optical element is a plastic ophthalmic lens.
